(19) United States
(12) Patent Application Publication
(10) Pub. No.: US 2006/0109138 A1
(43) Pub. Date: May 25, 2006

(54) Apparatus and method for interactive touch screen remote control

(76) Inventor: Shao-Pin Chiang, Toufen Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/156,650

(22) Filed: Jun. 21, 2005

(30) Foreign Application Priority Data
Nov. 23, 2004 (TW) 93136023

(51) Int. Cl. G08C 19/00; G08C 19/12

(52) U.S. Cl. 340/825.69; 341/176

(57) ABSTRACT

A remote control apparatus with an acknowledge requesting signal button is provided, which sends an acknowledge requesting signal to a target appliance when pressed. The control circuit of a target appliance includes a device identification information storage unit for storing a pre-determined device identification of the appliance. Upon receiving an acknowledge requesting signal from the remote control apparatus, the target appliance responds with information including the device identification, the corresponding communication protocol of the appliance, and control button mapping. When the remote control apparatus receives the response from the target appliance, the display unit of the remote control apparatus displays the corresponding control button mapping (or layout) and configures the communication protocol for controlling the target appliance remotely. The apparatus also stores a plurality of device identifications so that a single apparatus is able to control a plurality of electrical appliances.

### FIELD OF THE INVENTION

The present invention relates to a remote control of electrical appliance technique and, more particularly, to an apparatus and a method for interactive touch screen remote control of electrical appliances.

### BACKGROUND OF THE INVENTION

For the target electrical appliances, most use infrared or radio frequency (RF) signal for remote control. The conventional technique is to include a remote receiving circuit in the control circuit of the target electrical appliance for receiving a remote signal from a remote controller. The remote signal can control various functions, such as the power on, power off, and tuning, of the target electrical appliance. For example, a remote controller of an air-conditioner can be used to turn on, turn off, adjust the temperature setting, and set the timer of the air-conditioner. Similarly, a remote controller of a television set can be used to turn on, turn off, switch channel, and tune the volume of the television set.

However, although the remote controller of the electrical appliances bas brought much convenience to the use of appliances, its usage is still limited. For example, a conventional remote controller can be used only to control a single target electrical appliance. A remote control cannot be shared by or used to control a plurality of electrical appliances. Therefore, it is common for a household to have a plurality of remote controllers, with each for a target electrical appliance.

Furthermore, the conventional remote controller only provides unidirectional control functions. That is, the user can use the predetermined control buttons on the remote controller to control operations of the target electrical appliance. Other than that, there is no interaction between the remote controller and the target electrical appliance. The user cannot use the remote controller in a more interactive fashion. Therefore, it is imperative to address the inconvenience of the conventional remote controllers to meet the demands of the user.

### SUMMARY OF THE INVENTION

The present invention is provided to overcome the aforementioned drawback of the conventional unidirectional remote controllers. A primary objective of the present invention is to provide an interactive remote control apparatus so that the user can control the target electrical appliance in an interactive fashion.

Another objective of the present invention is to provide a touch screen remote control apparatus. Through the integration of touch screen technology and the remote control technology of appliances, the user can use a touch screen to control the target appliance remotely.

Yet another objective of the present invention is to provide an interactive remote control apparatus with a feedback function for error notification. When the target appliance experiences a predetermined error, the remote control apparatus of the present invention displays the situation so that the user can either trouble-shoot the problem or perform the necessary maintenance.

To achieve the aforementioned objectives, the present invention provides a remote control apparatus with an acknowledge requesting signal button, which sends an acknowledge requesting signal to a target appliance when pressed. The control circuit of a target appliance must include a device identification information storage unit for storing a predetermined device identification of the appliance. Upon receiving an acknowledge requesting signal from the remote control apparatus, the target appliance responds with information including the device identification, the corresponding communication protocol of the appliance, and control button mapping. When the remote control apparatus receives the response from the target appliance, the display unit of the remote control apparatus displays the corresponding control button mapping (or layout) and configure the communication protocol for controlling the target appliance remotely.

In a preferred embodiment of the present invention, a single interactive remote control apparatus can control a plurality of target appliances. The display unit of the touch screen module can display device identifications of a plurality of target appliances simultaneously for the user to control any target appliance remotely.

The present invention, compared to the conventional remote control apparatus, provides more interactivity and convenience. The use of touch screen display function allows the user to replace the old-fashioned button control. Furthermore, when a predetermined error occurs in the target appliance, the remote control apparatus is notified and displays the error so that the troubleshooting or the necessary maintenance can be performed.

These and other objectives, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a first embodiment of an interactive remote control apparatus of the present invention;

FIG. 2 shows a block diagram of the control circuit of an interactive remote control apparatus of the present invention;

FIG. 3 shows a block diagram of the control circuit at a target electrical appliance;

FIG. 4 shows a flowchart of device identification access and display control of an interactive remote control apparatus of the present invention;

FIG. 5 shows a flowchart of the remote controlling of a target electrical appliance by an interactive remote control apparatus of the present invention;

FIG. 6 shows a flowchart of the control display when an error of an target appliance occurs; and

FIG. 7 shows a schematic view of a second embodiment of an interactive remote control apparatus of the present invention.

### DETAILED DESCRIPTION OF PREFERRED EMBODIMENT

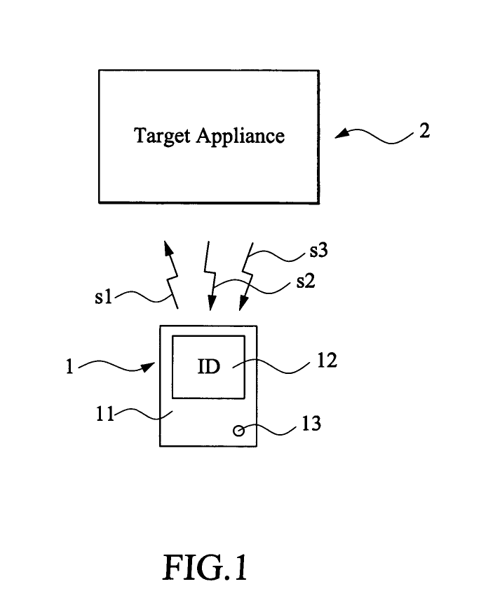

FIG. 1 shows a schematic view of a first embodiment of an interactive remote control apparatus of the present invention, which is designated with reference numeral 1. Through the remote control apparatus of the present invention, a target electrical appliance can be operated in an interactive fashion. The interactive remote control apparatus 1 of the present invention includes a module case 11, which is equipped with a touch screen display module 12. An acknowledge request button 13 is arranged close to the touch screen display module 12 for sending a device acknowledge request signal S1 from the remote control apparatus 1 to a target electrical appliance 2 when pressed by the user. The target appliance 2 is given predetermined device identification.

Upon receiving the acknowledge request signal S1, the target appliance 2 responds with a signal S2 containing the device identification to the interactive remote control apparatus 1. Based on the device identification contained in the signal S2, the interactive remote control apparatus 1 displays the corresponding control buttons of the target appliance 2 on the touch screen display module 12 for the user to perform the remote control of the target appliance 2.

In addition, when an error occurs in the target appliance 2, the target appliance 2 sends an error signal S3 containing the code of error to the interactive remote control apparatus 1. The interactive remote control apparatus 1 displays the error code and the error message on the touch screen display module 12.

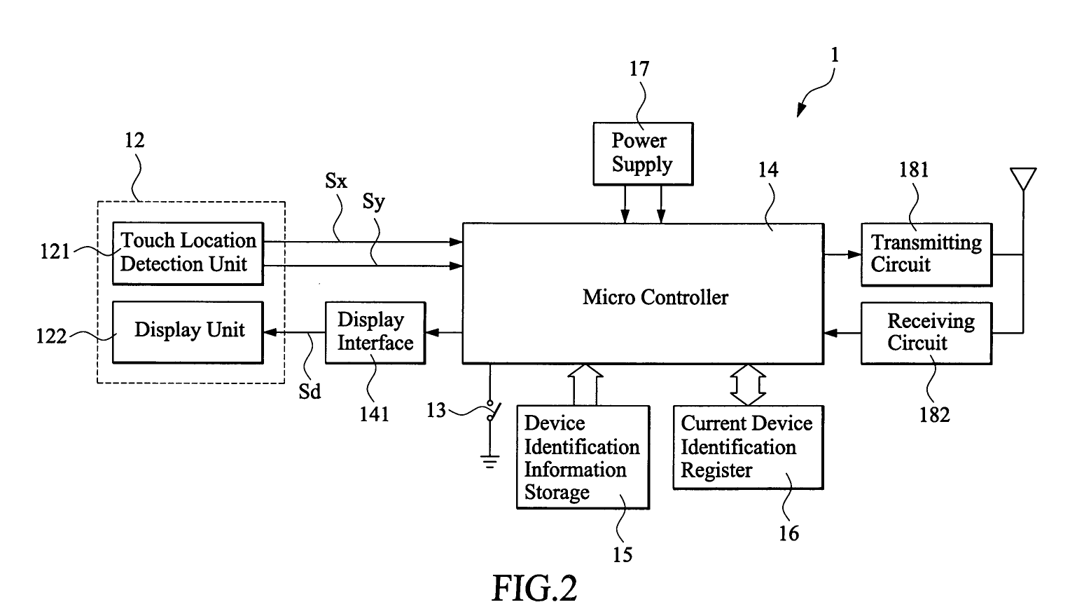

FIG. 2 shows a block diagram of the control circuit of the interactive remote control apparatus 1 of the present invention. The control circuit includes a micro controller 14, connected to the touch screen display module 12. The touch screen display module 12 includes a touch location detection unit 121 and a display unit 122.

The touch screen display module 12 can be implemented with a resistive touch screen or liquid crystal display (LCD) technology. The main structure of the touch screen display unit 12 is to place a spacer dot matrix between two touch layers, and embed the combined structure in a conductive substrate (not shown). When the touch screen display module 12 is pressed, the (X, Y) coordinates of the pressed location will be detected by the touch location detection unit 121. Two location signals Sx and Sy, indicating the (X, Y) coordinates of the pressed location, are sent through signal output line to the micro controller 14. The micro controller 14 sends a display information Sd through a display interface 141 to the display unit 122 of the touch screen display module 12 for displaying related information.

The micro controller 14 is connected to device identification information storage 15. The device identification information storage 15 stores a plurality of predetermined device identification and corresponding communication protocol, control button layout, and so on. A current device identification register 16 is connected to the micro controller 14 for storing the device identifications of the devices currently in use.

A power supply 17 provides the operating voltage for interactive remote control apparatus 17. A transmitting circuit 181 and a receiving circuit 182 are connected to the micro controller 14 for transmitting and receiving radio frequency (RF) signals.

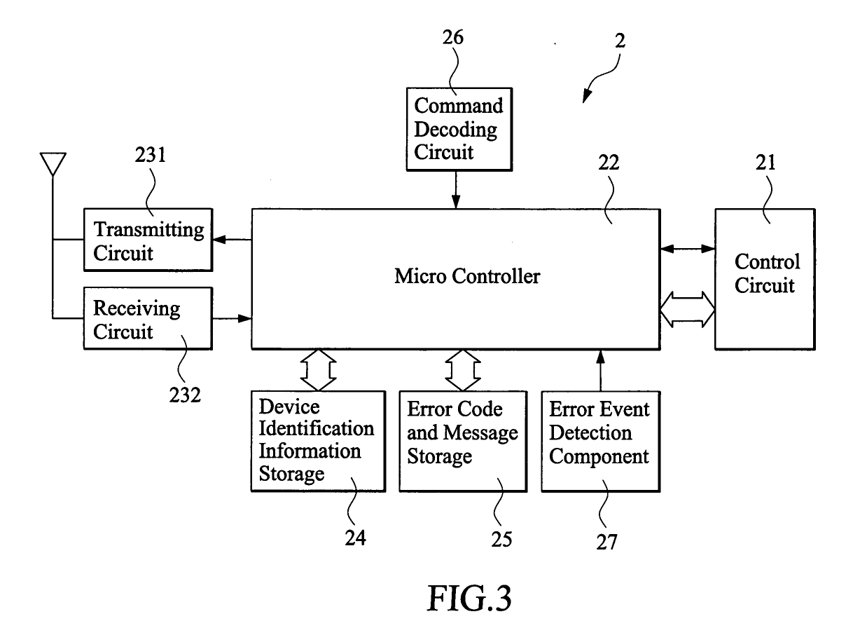

FIG. 3 shows a block diagram of the control circuit at a target electrical appliance. The target appliance 2 includes a control circuit 21 for controlling the functions of the target appliance 2. The control circuit 21 of the target appliance 2 includes a micro controller 22, which is connected to a transmitting circuit 231, a receiving circuit 232, device identification information storage 24, an error code and message storage 25, and a command decoding circuit 26. The device identification information storage 24 stores the predetermined identification, communication protocol, control button layout, and other related information of the device.

The error code and message storage 25 stores a plurality of error codes and error messages of error situations during the operation of the target appliance 2. For example, when the target appliance 2 is an air-conditioner, the error messages may include the filter requiring replacement, compressor malfunction, and so on.

The micro controller 22 of the control circuit 21 of the target appliance 2 is connected to at least an error event detection component 27 for detecting error situation of the target appliance 2. For example, when the target appliance 2 is an air-conditioner, the error event detection component 27 can be a timer for accumulating the time in order to notify the necessity of filter replacement. The error event detection component 27 can also be a temperature sensor for sensing whether the temperature of the compressor is too high.

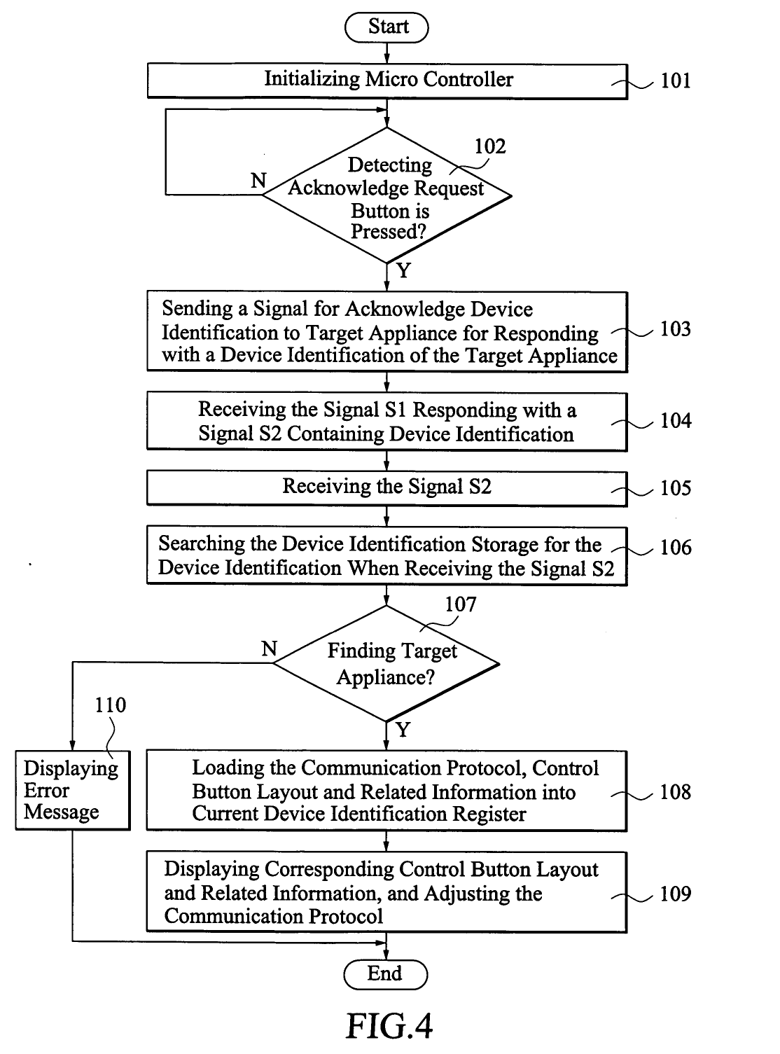

FIG. 4 shows a flowchart of device identification access and display control of an interactive remote control apparatus of the present invention. The following description also refers to FIGS. 2 and 3.

When power supply to the interactive remote control apparatus 1 is normal, the micro controller 14 is initialized (step 101). Then, the micro controller 14 monitors whether the acknowledge request button 13 on the module case 11 is pressed for sending a signal (step 102).

When the micro controller 14 detects that the acknowledge request button 13 on the module case 11 is pressed, a transmitting circuit 181 of the interactive remote control apparatus 1 sends a signal S1 for acknowledge device identification to the target appliance 2 for responding with a device identification of the target appliance 2 (step 103).

Upon receiving the signal S1 from the interactive remote control apparatus 1, the target appliance 2 responds with a signal S2 containing device identification (step 104). The signal S2 is received by the receiving circuit 182 of the interactive remote control apparatus 1 (step 105).

When the receiving circuit 182 of the interactive remote control apparatus 1 receives the signal S2 sent by the target appliance 2 in response, the micro controller 14 searches the device identification storage 15 for a match of the device identification contained in signal S2 (step 106).

When the micro controller 14 of the interactive remote apparatus 1 finds a match of the target appliance in device identification storage 15 (step 107), the micro controller 14 loads the corresponding communication protocol, control button layout and related information into current device identification register 16 (step 108).

The micro controller 14 displays, through the display interface 141, the corresponding control button layout and related information on the display unit 122 of the touch screen display module 12, and adjusts the communication protocol (step 109). After this step, the user can press the number or control button displayed on the display unit 122 of the touch screen display module 12 to control the functions of the target appliance 2. The control buttons can be displayed with text or icons for the easy identification of the user.

In step 107, if the micro controller cannot find a match for the device identification in device identification information storage 15, the micro controller will display, through the display interface 141, an error message on the display unit 122 of the touch screen display module 2 (step 110).

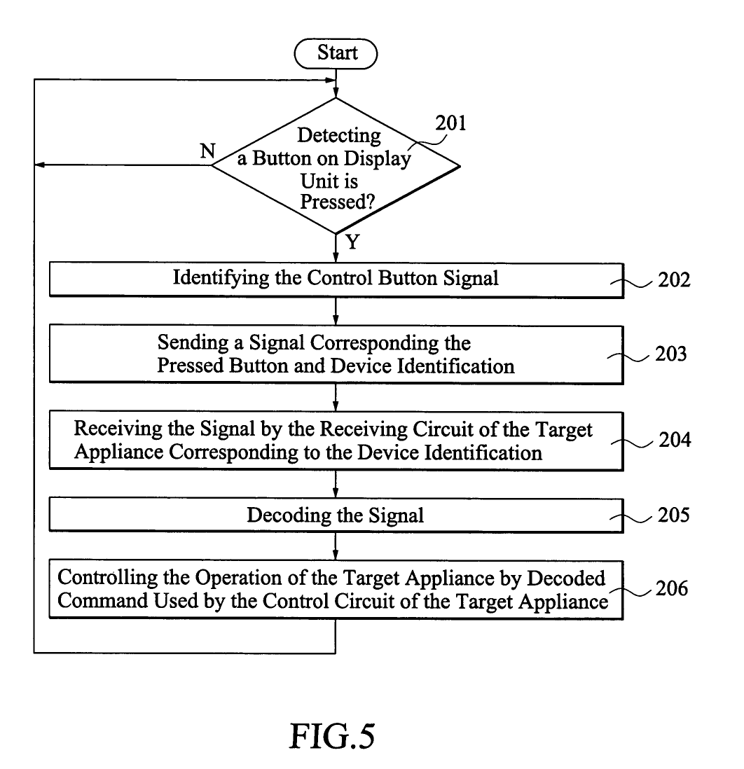

FIG. 5 shows a flowchart of the remote controlling of a target electrical appliance by an interactive remote control apparatus of the present invention. When the interactive remote control apparatus 1 of the present invention obtains the control through the process in FIG. 4, the user can use the interactive remote control apparatus 1 to control the functions of the target appliance 2.

When the micro controller 14 detects, through the touch screen display module 12, that the user has pressed a button on the display unit 122 (step 201), the micro controller identifies the control button signal (step 202) and sends, through the transmitting circuit 181, a signal corresponding the pressed button and device identification (step 203) to the target appliance 2.

The signal sent by the interactive remote control apparatus 1 is received by the receiving circuit 231 of the target appliance corresponding to the device identification contained in the signal (step 204), and decoded by command decoding circuit 26 (step 205). The decoded command can be used by the control circuit 21 of the target appliance 2 to control the operation of the target appliance 2 (step 206).

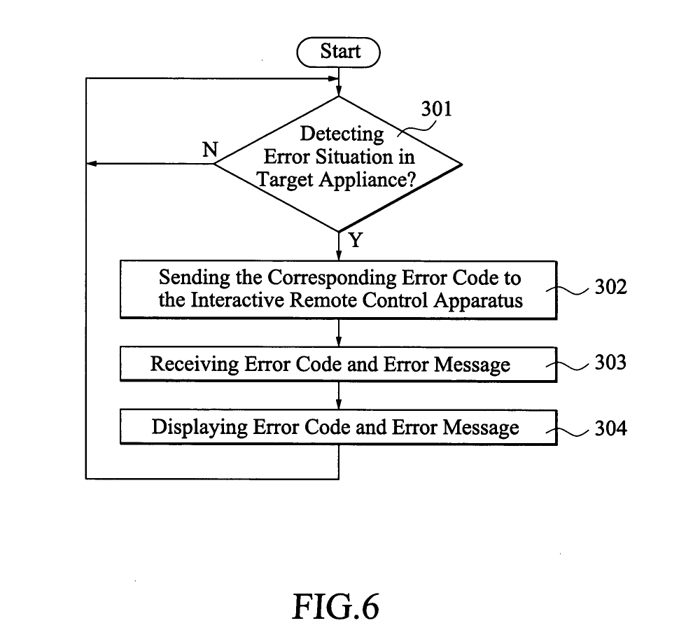

FIG. 6 shows a flowchart of the control display when an error of the target appliance occurs. When the target appliance 2 operates normally, the micro controller 22 of the target appliance 2 monitors to detect, through error the event detection component 27, whether an error situation has occurred in target appliance 2 (step 301). When an error situation is detected, the micro controller 22 sends, through the transmitting circuit 231, the corresponding error code stored in the error code and message storage 25 to the interactive remote control apparatus 1 (step 302).

Upon receiving the error code and error message sent by the target appliance 2 (step 303), the micro controller 14 interactive the remote control apparatus 1 will display, through the display interface 141, the error code and error message on the display unit 122 of the touch screen display module 12 (step 304). When the target appliance 2 has a predetermined error situation, the user can be notified with the situation and perform the necessary maintenance in time.

In the above embodiment, a single interactive remote control apparatus is used to control a single electrical appliance. In the practice, a single interactive remote control apparatus can be used to control a plurality of target appliances.

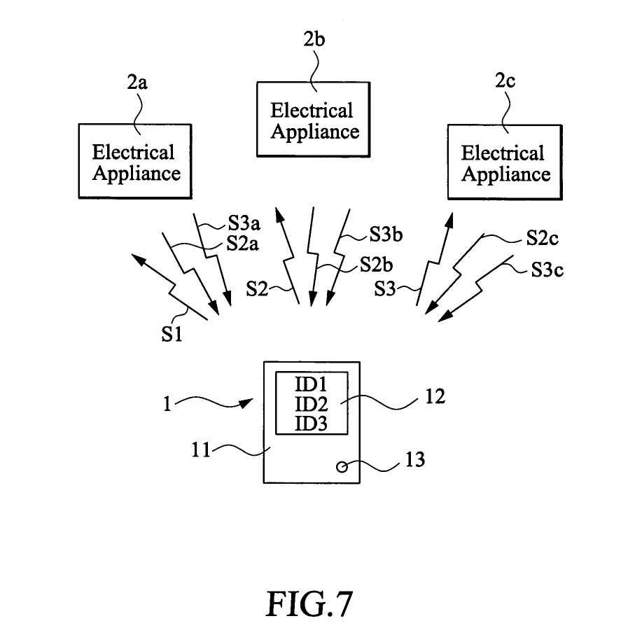

FIG. 7 shows a second embodiment of the present invention. In this embodiment, a single interactive remote control apparatus 1 corresponds to a plurality of electrical appliances 2a, 2b, 2c. The interactive remote control apparatus 1 includes a module case 11, a touch screen display module 12, and an acknowledge request button 13. Each target appliance 2a, 2b, 2c is given an independent device identification ID1, ID2, ID3, also stored in the interactive remote control apparatus 1.

Upon receiving the acknowledge request signal S1, the target appliance 2a, 2b, 2c respond with a signal S1a, S2b, S2c containing its device identification to the interactive remote control apparatus, respectively. The interactive remote control apparatus 1 displays device identification ID1, ID2, ID3 on the touch screen display module simultaneously for the user to select the target appliance to control. When the user selects a target appliance, the interactive remote control apparatus 1 displays the corresponding control button layout on the touch screen display module for controlling the selected target appliance according to the selected device identification.

Furthermore, when the target appliance 2a, 2b, 2c has a predetermined error situation, an error code signal S3a, S3b, S3c is sent to the interactive remote control apparatus 1 and displayed on the touch screen display module 12. The remaining operation is similar to that of the first embodiment.

The above description shows that the interactive remote control apparatus of the present invention can achieve the objects to overcome the drawbacks of the conventional techniques. While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. An apparatus for remotely controlling operations of at least an electrical appliance, said remote control apparatus comprising:
a module case;
a micro controller;
a transmitting circuit, connected to said micro controller;
a receiving circuit, connected to said micro controller;
an acknowledge request button, detected by said micro controller when pressed, and sending a device acknowledge signal through said transmitting circuit; and
a touch screen display module, placed on said module case and connected to said micro controller, further comprising a touch location detection component and a display unit;
and said electrical appliance comprising:
a target appliance control circuit, further comprising:
a micro controller, for controlling operations of said electrical appliance;
a transmitting circuit, connected to said micro controller;
a receiving circuit, connected to said micro controller; and
a device identification information storage, connected to said micro controller for storing a predetermined device identification and corresponding communication protocol and control button layout of said electrical appliance;
wherein when said acknowledge request button being pressed, said transmitting circuit of said remote control apparatus sending a requesting acknowledge signal to said electrical appliance; said receiving circuit of the electrical appliance receiving said requesting acknowledge signal, responding with an acknowledge signal containing said device identification and said corresponding communication protocol and said control button layout thereof to said apparatus; said remote control apparatus receiving said responding acknowledge signal and displaying said control button layout on said display unit of said touch screen display module and adjusting said communication protocol for controlling said electrical appliance remotely.

2. The apparatus as claimed in claim 1 further comprising a device identification storage in the remote control apparatus, connected to said micro controller for storing at least a set of device identification, communication protocol and control button layout corresponding to said device identification.

3. The apparatus as claimed in claim 1 further comprising a current device identification register in the remote control apparatus, connected to said micro controller for storing said device identification, communication protocol and control button layout corresponding to said device identification of said electrical appliance currently being controlled.

4. The apparatus as claimed in claim 3, wherein said current device identification register stores a plurality of device identifications, communication protocols and button control layouts corresponding to said device identifications of said electrical appliances.

5. The apparatus as claimed in claim 1, wherein said electrical appliance further comprises an error code and message storage, connected to said micro controller for storing a plurality of error codes and error messages; when a predetermined error situation occurring, said transmitting circuit of said electrical appliance sending said error code and error message to said apparatus.

6. An apparatus for remotely controlling operations of at least an electrical appliance, said remote control apparatus comprising:
a module case;
a micro controller;
a transmitting circuit, connected to said micro controller;
a receiving circuit, connected to said micro controller;
an acknowledge request button, detected by said micro controller when pressed, and sending a device acknowledge signal through said transmitting circuit;
a touch screen display module, placed on said module case and connected to said micro controller, further comprising a touch location detection component and a display unit; and
a device identification storage, connected to said micro controller for storing at least a set of device identification, communication protocol and control button layout corresponding to said device identification;
and said electrical appliance comprising:
a target appliance control circuit, further comprising:
a micro controller, for controlling operations of said electrical appliance;
a transmitting circuit, connected to said micro controller;
a receiving circuit, connected to said micro controller; and
a device identification information storage, connected to said micro controller for storing a predetermined device identification;
wherein when said acknowledge request button being pressed, said transmitting circuit of said apparatus sending a requesting acknowledge signal to said electrical appliance; said receiving circuit of the electrical appliance receiving said requesting acknowledge signal, responding with an acknowledge signal containing said device identification thereof to said remote control apparatus; said remote control apparatus receiving said responding acknowledge signal and then searching for a match with said device identification contained in the acknowledge signal in the device identification information storage, and after finding a match, loading corresponding communication protocol and control button layout and displaying said control button layout on said display unit of said touch screen display module and adjusting said communication protocol for controlling said electrical appliance remotely.

7. The apparatus as claimed in claim 6 further comprising a current device identification register in the remote control apparatus, connected to said micro controller for storing said device identification, communication protocol and control button layout corresponding to said device identification of said electrical appliance currently being controlled.

8. The apparatus as claimed in claim 7, wherein said current device identification register stores a plurality of device identifications, communication protocols and button control layouts corresponding to said device identifications of said electrical appliances.

9. The apparatus as claimed in claim 6, wherein said electrical appliance further comprising an error code and message storage, connected to said micro controller for storing a plurality of error codes and error messages; when a pre-determined error situation occurring, said transmitting circuit of said electrical appliance sending said error code and error message to said apparatus.

10. A method for interactive remote touch screen controlling of an electrical appliance, using an interactive touch screen remote control apparatus having a micro controller, a transmitting circuit, a receiving circuit, an acknowledge request button and a touch screen display module having a touch location detection component and a display unit, said electrical appliance having a control circuit, a transmitting circuit, a receiving circuit, and a device identification information storage, said device identification information storage storing a predetermined device identification, said method comprising:
(a) detecting whether said acknowledge request button being pressed;
(b) sending an acknowledge requesting signal through transmitting circuit of said apparatus;
(c) said requesting signal being received by said receiving circuit of said electrical appliance, said transmitting circuit of said electrical appliance sending a responding signal containing a device identification of said electrical appliance;
(d) said apparatus receiving said responding signal sent by said electrical appliance; and
(e) said apparatus displaying corresponding control button layout of said device identification on said display unit of said touch screen display module for controlling said electrical appliance.

11. The method as claimed in claim 10, wherein said step (d) further comprises a step of searching for a match with said device identification in a device identification information storage, and after finding a match, loading corresponding communication protocol and control button layout.

12. The method as claimed in claim 10, wherein said step (d) further comprises a step of storing said device identification in a current device identification register.

13. The method as claimed in claim 10, wherein said step (e) further comprises a step of displaying a plurality of device identifications of a plurality of electrical appliances for users to select a target appliance for controlling.

14. The method as claimed in claim 10 further comprising steps of:
(f) an error event detection unit of said electrical appliance detecting whether an error occurring;
(g) said transmitting circuit of said electrical appliance sending a corresponding error code and error message when detecting an error event;
(h) said apparatus receiving said error code and said error message; and
(i) said apparatus displaying said error code and said error message on said display unit of said touch screen display module of said apparatus.
